(19) United States
(12) Patent Application Publication
(10) Pub. No.: US 2024/0124347 A1
(43) Pub. Date: Apr. 18, 2024

(54) FLEXIBLE GLASS AND PREPARATION METHOD THEREFOR

(71) Applicant: CAIHONG DISPLAY DEVICES CO., LTD., Xianyang (CN)

(72) Inventors: Guohong YANG, Xianyang (CN); Zhao ZENG, Xianyang (CN); Dacheng WANG, Xianyang (CN); Lihua XU, Xianyang (CN)

(73) Assignee: CAIHONG DISPLAY DEVICES CO., LTD., Xianyang (CN)

(21) Appl. No.: 18/399,509

(22) Filed: Dec. 28, 2023

Related U.S. Application Data
(63) Continuation of application No. PCT/CN2023/084863, filed on Mar. 29, 2023.

(30) Foreign Application Priority Data
Mar. 30, 2022 (CN) 2022103271936

(51) Int. Cl. C03C 3/091

(52) U.S. Cl. CPC C03C 3/091; C03B 17/04

(57) ABSTRACT

Disclosed are flexible glass and a preparation method therefor; weight proportions of the raw materials used in the flexible glass are: 60.04-63.01 parts silicon dioxide, 16.7-21.5 parts aluminum oxide, 12.93-19.85 parts boron oxide, 2.43-14.19 parts calcium carbonate, 0.16-2.07 parts magnesium oxide. 0.5-2.74 parts strontium carbonate and 0-4.16 parts barium nitrate. The method includes: step 1: pouring raw materials into a mixer, and uniformly mixing to form a mixture; step 2: adding the mixture into a glass furnace, heating to melt the glass, and the melted glass entering a platinum feeding channel for clarification and flowing into a tube drawing tunnel; step 3: drawing the liquid glass into a long glass tube; step 4: using a laser cutting machine to transversely and longitudinally cut the glass tube according to specification requirements, forming a glass sheet; step 5: inspecting the glass sheet, and preparing a flexible glass product.

### CROSS-REFERENCE TO RELATED APPLICATIONS

The application claims priority to Chinese patent application No. 2022103271936, filed on Mar. 30, 2022, the entire contents of which are incorporated herein by reference.

### TECHNICAL FIELD

The present disclosure belongs to the field of photoelectric display, and particularly belongs to flexible glass and a preparation method therefor.

### BACKGROUND

Flexible glass refers to a glass material with a thickness of <0.1 mm and good bending toughness. The smaller the thickness, the smaller the bending critical radius. In addition to good flexibility, flexible glass still maintains the inherent characteristics of glass, such as high hardness, high transparency, high thermal stability and chemical corrosion resistance. Flexible glass will be widely used in photoelectric display, lighting, solar energy and aerospace.

According to the research status at home and abroad, the preparation methods for flexible glass may be divided into primary forming and secondary forming according to the number of stages. The primary forming includes an overflow downdraw method, a float method and a slit downdraw method; and the secondary forming includes a chemical thinning method and a redraw method.

The overflow downdraw method is invented by Corning Inc., US in 1967. The overflow downdraw method relies on the gravity of the glass to draw the glass thinner, and the two surfaces of the glass are not in contact with external materials during the forming annealing process. so that the surface of a finished product is smooth and flawless, with good flatness, and there is no need for subsequent processing such as polishing. Moreover, both sides of the glass can be controlled by rollers to be heated or cooled at the same time, thus the overflow downdraw method is suitable for the preparation of flexible glass with high surface quality requirements. However, in this process, the liquid glass meets the overflow brick tip to form the root of the glass panel, which has the foundation thickness and increases the difficulty of thinning.

In the late 1950s, Pilkington Glass, UK announced to the world that the glass float forming process had been developed successfully. The process delivers molten glass to a liquid tin bath, and the molten glass has low density and floats on the surface of the tin liquid for forming. The capacity scale is large, and the product specifications are complete. If this method is used to produce flexible glass, it is necessary to add several pairs of edge rollers and traction rollers to overcome the gravity and surface tension of liquid glass and realize the thickness reduction. In addition, because the glass ribbon floats on the surface of the tin liquid, a tin penetration layer will be formed on the lower surface, so that further processing is needed.

At the end of the 20th century, Schott GmbH. Germany developed the slit downdraw technology. At present, this technology is used to produce flexible glass products with a thickness of 0.03 mm-0.1 mm. The slit downdraw method is to guide molten homogeneous glass into evenly heated platinum-rhodium storage tank, enable the glass to flow out through the slit of platinum bushing, and draw the glass by means of edge rollers and traction rollers. The method is suitable for producing flexible glass with less viscosity, less floor space, and short construction cycles. However, the flatness of the product surface and the stability of production are easily affected by the shape of the slit.

The redraw method is to heat raw glass to a temperature above the softening point at which the glass becomes viscoelastic and has certain fluidity and draw and thin the glass by applying a traction force to prepare flexible glass with a thickness of less than 100 μm. The redraw method has the advantages of small equipment investment and small production site space, and flexible glass can be continuously produced by continuously inputting raw glass. It is found that in the drawing and thinning process, due to the influence of surface tension, the raw glass is subjected to a large lateral contraction force causing a sharp contraction of the width after the raw glass has been drawn, with the width of the prepared flexible glass being even less than 30% the original width, making it difficult to produce large-sized flexible glass, and the thickness difference is 10 μm-15 μm, the surface roughness is greater than 0.110 μm, and the surface quality is not good, so it is difficult for the redraw method to be used in the field of photoelectric display.

The chemical thinning method is a method to change the surface structure of glass by etching the glass surface with an acid solution to reduce the thickness of glass, but the glass is fragile in the subsequent polishing process and the yield is low.

In summary, it is difficult for the flexible glass produced in the prior art to meet the display requirement of higher resolution.

### SUMMARY

### Technical Problem

In a drawing and thinning process, due to the influence of surface tension, raw glass is subjected to a large lateral contraction force causing a sharp contraction of the width after the raw glass has been drawn, with the width of the prepared flexible glass being even less than 30% the original width, making it difficult to produce large-sized flexible glass, and the thickness difference is 10 μm-15 μm, the surface roughness is greater than 0.110 μm, and the surface quality is not good, so it is difficult for the redraw method to be used in the field of photoelectric display.

The chemical thinning method is a method to change the surface structure of glass by etching the glass surface with an acid solution to reduce the thickness of glass, but the glass is fragile in the subsequent polishing process and the yield is low.

### Technical Solution

In order to solve the problems existing in the prior art, the present disclosure provides flexible glass and a preparation method therefor, which are used to solve the above problems.

In order to achieve the above object, the present disclosure provides the following technical solutions:
there is provided flexible glass, wherein the weight proportions of the raw materials used in the flexible glass are: 60.04-63.01 parts silicon dioxide, 16.7-21.5 parts aluminum oxide, 12.93-19.85 parts boron oxide, 2.43-14.19 parts calcium carbonate, 0.16-2.07 parts magnesium oxide, 0.5-2.74 parts strontium carbonate and 0-4.16 parts barium nitrate.

Preferably, the flexible glass has a strain point temperature Ts ranging from 670° C. to 739° C.

Preferably, the flexible glass has a Young's modulus ranging from 70 GPa to 83 GPa.

Preferably, the flexible glass has a density ranging from 2.38 g/cm³ to 2.43 g/cm³.

A preparation method for flexible glass, including the following steps:
step 1, pouring raw materials into a mixer and mixing uniformly to form a mixture; wherein the weight proportions of the raw materials are: 60.04-63.01 parts silicon dioxide, 16.7-21.5 parts aluminum oxide, 12.93-19.85 parts boron oxide, 2.43-14.19 parts calcium carbonate, 0.16-2.07 parts magnesium oxide, 0.5-2.74 parts strontium carbonate and 0-4.16 parts barium nitrate;
step 2, adding the mixture obtained in step 1 into a glass furnace via a feeding machine, heating to melt the glass, and the melted glass entering a platinum feeding channel for clarification and flowing into a tube drawing tunnel;
step 3, drawing the liquid glass into a long glass tube in the tube drawing tunnel by means of a tube drawing traction machine, wherein the inside of the tube drawing tunnel has a polar atmosphere;
step 4, using a laser cutting machine to transversely and longitudinally cut the glass tube according to specification requirements to form a glass sheet; and
step 5, inspecting the glass sheet, and preparing a flexible glass product.

Preferably, in step 2, a melting temperature of the glass ranges from 1550° C. to 1600° C.

Preferably, in step 2, a clarifying agent for the flexible glass is tin oxide.

Preferably, in step 2, the glass is melted by means of electric heating and natural gas combustion.

Preferably, in step 3, the polar atmosphere is water vapor.

Preferably, in step 3, the long glass tube has a thickness of less than 0.1 mm.

Beneficial Effects

Compared with the prior art, the present disclosure has the following beneficial technical effects:

the present disclosure provides a flexible glass, which has high strain point temperature, high Young's modulus and low density, and can meet the display requirements of higher resolution; the present disclosure provides a preparation method for flexible glass, which reduces the surface tension of the liquid glass through the polar atmosphere (such as water vapor) inside the tube drawing tunnel, and reduces the difficulty of drawing flexible glass having a thickness of less than 0.1 mm. Moreover, the stronger the polarity of the atmosphere medium, the greater the orientation force, and the more the surface tension of the glass liquid is reduced, and at the same time, the water inside the liquid glass is hindered from continuing to decompose to form oxygen bubbles and hydrogen bubbles, and the bubble defects inside the glass are reduced.

### DETAILED DESCRIPTION OF THE EMBODIMENTS

The present disclosure will be further described in detail below with reference to specific examples, which are intended to explain, but not to limit, the present disclosure.

### Example 1

The weight proportions of raw materials used in flexible glass according to the present disclosure are:
60.04 parts silicon dioxide, 20.07 parts aluminum oxide, 18.68 parts boron oxide, 13.4 parts calcium carbonate, 0.78 parts magnesium oxide, 1.63 parts strontium carbonate, 0.29 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1550° C. and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere, the polar atmosphere may be ammonia, HCl, SO2 and water vapor, and water vapor is adopted in this example.
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 723° C.;
the flexible glass prepared by this method has a Young's modulus of 79 GPa;
the flexible glass prepared by this method has a density of 2.39 g/cm3.

### Example 2

The weight proportions of raw materials are:
62.07 parts silicon dioxide, 21.5 parts aluminum oxide, 13.58 parts boron oxide, 13.45 parts calcium carbonate, 0.16 parts magnesium oxide, 1.63 parts strontium carbonate, 0.29 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1600° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 739° C.;
the flexible glass prepared by this method has a Young's modulus of 83 GPa:
the flexible glass prepared by this method has a density of 2.38 g/cm3.

### Example 3

The weight proportions of raw materials are:
62.08 parts silicon dioxide, 20.18 parts aluminum oxide, 12.93 parts boron oxide, 11.76 parts calcium carbonate, 0.8 parts magnesium oxide, 1.16 parts strontium carbonate, 3.73 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1560° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 729° C.;
the flexible glass prepared by this method has a Young's modulus of 82 GPa;
the flexible glass prepared by this method has a density of 2.4 g/cm3.

### Example 4

The weight proportions of raw materials are:
62.63 parts silicon dioxide, 17.37 parts aluminum oxide, 18.93 parts boron oxide, 13.58 parts calcium carbonate, 1.44 parts magnesium oxide, 0.5 parts strontium carbonate, 0.29 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1570° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 694° C.;
the flexible glass prepared by this method has a Young's modulus of 81 GPa;
the flexible glass prepared by this method has a density of 2.38 g/cm3.

### Example 5

The weight proportions of raw materials are:
61.65 parts silicon dioxide, 17.09 parts aluminum oxide, 18.64 parts boron oxide, 13.36 parts calcium carbonate, 1.42 parts magnesium oxide, 2.74 parts strontium carbonate, 0.29 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1580° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product,

The flexible glass prepared by this method has a strain point temperature Ts of 679° C.;
the flexible glass prepared by this method has a Young's modulus of 74 GPa;
the flexible glass prepared by this method has a density of 2.42 g/cm3.

### Example 6

The weight proportions of raw materials are:
62.28 parts silicon dioxide, 16.99 parts aluminum oxide, 18.52 parts boron oxide, 11.77 parts calcium carbonate, 1.37 parts magnesium oxide, 1.61 parts strontium carbonate, 4.16 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1590° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 688° C.;
the flexible glass prepared by this method has a Young's modulus of 76 GPa:
the flexible glass prepared by this method has a density of 2.43 g/cm3.

### Example 7

The weight proportions of raw materials are:
61.9 parts silicon dioxide, 18.72 parts aluminum oxide, 15.87 parts boron oxide, 14.19 parts calcium carbonate, 1.42 parts magnesium oxide, 1.63 parts strontium carbonate, 0.29 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1550° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 714° C.;
the flexible glass prepared by this method has a Young's modulus of 77 GPa;
the flexible glass prepared by this method has a density of 2.4 g/cm3.

### Example 8

The weight proportions of raw materials are:
63.01 parts silicon dioxide, 17.04 parts aluminum oxide, 19.85 parts boron oxide, 2.43 parts calcium carbonate, 1.42 parts magnesium oxide, 1.81 parts strontium carbonate, 0.29 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1600° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 683° C.;
the flexible glass prepared by this method has a Young's modulus of 72 GPa;
the flexible glass prepared by this method has a density of 2.4 g/cm3.

### Example 9

The weight proportions of raw materials are:
62.89 parts silicon dioxide, 16.7 parts aluminum oxide, 19.02 parts boron oxide, 12.01 parts calcium carbonate, 2.07 parts magnesium oxide, 1.64 parts strontium carbonate, and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1550° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 686° C.;
the flexible glass prepared by this method has a Young's modulus of 71 GPa;
the flexible glass prepared by this method has a density of 2.39 g/cm3.

### Example 10

The weight proportions of raw materials are:
62.08 parts silicon dioxide, 17.21 parts aluminum oxide, 19.73 parts boron oxide, 12.88 parts calcium carbonate, 1.35 parts magnesium oxide, 1.56 parts strontium carbonate, 0.27 parts barium nitrate and 0.12 parts tin oxide.

A preparation method for the flexible glass includes a control computer system, an electronic scale, a mixer, a feeding machine, a glass furnace, a platinum feeding channel, a tube drawing traction machine, a tube drawing tunnel, an automatic laser detector, and a laser cutting machine.

The specific preparation process is as follows:
a, blending: weighing raw materials according to the proportions in this example, and then enabling the raw materials to enter the mixer for uniform mixing;
b, melting and clarification: adding a mixture into the glass furnace via the feeding machine, melting the glass by electric heating and natural gas combustion with the melting temperature being automatically controlled to 1600° C., and the melted glass entering the platinum feeding channel for clarification and flowing into the tube drawing tunnel;
c, forming: drawing the liquid glass into a long glass tube having a thickness of less than 0.1 mm by the tube drawing traction machine in the tube drawing tunnel, wherein the inside of the tube drawing tunnel has a polar atmosphere,
d, precision cutting: using the laser cutting machine to transversely and longitudinally cut the glass tube according to specification requirements; and
e, inspecting and packaging to prepare a flexible glass product.

The flexible glass prepared by this method has a strain point temperature Ts of 670° C.;
the flexible glass prepared by this method has a Young's modulus of 70 GPa;
the flexible glass prepared by this method has a density of 2.39 g/cm3.

What is claimed is:

1. Flexible glass, wherein weight ratio of raw materials used in the flexible glass is: 60.04-63.01 parts silicon dioxide, 16.7-21.5 parts aluminum oxide, 12.93-19.85 parts boron oxide, 2.43-14.19 parts calcium carbonate, 0.16-2.07 parts magnesium oxide, 0.5-2.74 parts strontium carbonate and 0-4.16 parts barium nitrate.

2. The flexible glass according to claim 1, wherein the flexible glass has a strain point temperature Ts ranging from 670° C. to 739° C.

3. The flexible glass according to claim 1, wherein the flexible glass has a Young's modulus ranging from 70 GPa to 83 GPa.

4. The flexible glass according to claim 1, wherein the flexible glass has a density ranging from 2.38 g/cm³ to 2.43 g/cm³.

5. A preparation method for flexible glass, comprising the following steps:
step 1, pouring raw materials into a mixer and mixing uniformly to form a mixture; wherein weight proportions of raw materials are: 60.04-63.01 parts silicon dioxide, 16.7-21.5 parts aluminum oxide, 12.93-19.85 parts boron oxide, 2.43-14.19 parts calcium carbonate, 0.16-2.07 parts magnesium oxide, 0.5-2.74 parts strontium carbonate and 0-4.16 parts barium nitrate;
step 2, adding the mixture obtained in step 1 into a glass furnace via a feeding machine, heating to melt the glass, and the melted glass entering a platinum feeding channel for clarification and flowing into a tube drawing tunnel;
step 3, drawing the liquid glass into a long glass tube in the tube drawing tunnel by means of a tube drawing traction machine, wherein the inside of the tube drawing tunnel has a polar atmosphere;
step 4, using a laser cutting machine to transversely and longitudinally cut the glass tube according to specification requirements to form a glass sheet; and
step 5, inspecting the glass sheet, and preparing a flexible glass product.

6. The preparation method for flexible glass according to claim 5, wherein in step 2, a melting temperature of the glass ranges from 1550° C. to 1600° C.

7. The preparation method for flexible glass according to claim 5, wherein in step 2, a clarifying agent for the flexible glass is tin oxide.

8. The preparation method for flexible glass according to claim 5, wherein in step 2, the glass is melted by means of electric heating and natural gas combustion.

9. The preparation method for flexible glass according to claim 5, wherein in step 3, the polar atmosphere is water vapor.

10. The preparation method for flexible glass according to claim 5, wherein in step 3, the long glass tube has a thickness of less than 0.1 mm.
